(19) United States
(12) Patent Application Publication
(10) Pub. No.: US 2010/0309353 A1
(43) Pub. Date: Dec. 9, 2010

(54) SOLID-STATE IMAGING DEVICE AND SEMICONDUCTOR DEVICE

(76) Inventor: Kenichiro HAGIWARA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/793,034

(22) Filed: Jun. 3, 2010

(30) Foreign Application Priority Data
Jun. 4, 2009 (JP) 2009-135254

(51) Int. Cl. H04N 5/335

(52) U.S. Cl. 348/294; 348/340; 348/E05.091; 348/E05.028

(57) ABSTRACT

According to one embodiment, a solid-state imaging device includes a substrate, a lens, a lens holder, and a metal shield. The substrate includes a pixel region having a first well and has a second well at a periphery thereof, the second well being independent of the first well. The lens is provided above the pixel region in the substrate. The lens holder holds the lens. The metal shield is provided on the substrate and the lens holder and electrically connected to the second well of the substrate

### CROSS-REFERENCE TO RELATED APPLICATIONS

This application is based upon and claims the benefit of priority from Japanese Patent Application No. 2009-135254, filed Jun. 4, 2009; the entire contents of which are incorporated herein by reference.

### FIELD

Embodiments described herein relate generally to a solid-state imaging device serving as a camera module using, for example, a CMOS image sensor, and a semiconductor device.

### BACKGROUND

A camera module having a CMOS image sensor and a lens unit includes analog circuits and digital circuits which are combined to process an image sensing signal. An analog circuit is easily influenced by noise. Hence, to attain a high-quality camera module, anti-noise measures are necessary.

Conventional anti-noise measures ensure grounding from the lower surface side of a substrate by adding external terminals for grounding or using a semiconductor substrate formed from a heavily doped p-type substrate and an n-type epitaxial layer. In addition, a technique has been developed, in which a ground sheet is provided on the entire lower surface of an image sensor, and a grid-shaped ground land having the same outer shape as that of the ground sheet of the image sensor is also provided on the upper surface of a substrate. The image sensor and substrate are bonded by an adhesive, thereby suppressing noise.

However, to meet recent requirements of reducing the sizes of electronic devices, CMOS image sensors are becoming more compact and sophisticated with lower voltages, and this is making the anti-noise measures more important than ever. For example, there is a strong demand to reduce the size of a camera module mounted in a cellular phone. There has recently been developed a camera module called a chip-scale camera module (CSCM) which has almost the same size as that of a chip. Such a CSCM structure also requires to sufficiently suppress EMC.

### BRIEF DESCRIPTION OF THE DRAWINGS

FIG. 1 is a sectional view showing the arrangement of a camera module according to an embodiment;

FIG. 2 is an enlarged sectional view of a main part in FIG. 1;

FIGS. 3A and 3B are views showing steps in the manufacture of the camera module according to the embodiment;

FIG. 4 is a sectional view showing the first modification of the camera module according to the embodiment;

FIG. 5 is a sectional view showing the second modification of the camera module according to the embodiment; and

FIG. 6 is a sectional view showing the third modification of the camera module according to the embodiment.

### DETAILED DESCRIPTION

In general, according to one embodiment, a solid-state imaging device includes a substrate, a lens, a lens holder, and a metal shield. The substrate includes a pixel region having a first well and has a second well at a periphery thereof, the second well being independent of the first well. The lens is provided above the pixel region in the substrate. The lens holder holds the lens. The metal shield is provided on the substrate and the lens holder and electrically connected to the second well of the substrate.

An embodiment will now be described with reference to the accompanying drawing. The same reference numbers denote the same parts throughout the drawing.

FIG. 1 is a sectional view of a camera module according to the embodiment.

As shown in FIG. 1, the camera module comprises an image sensor chip (semiconductor substrate) 10, translucent glass plate 20, lens unit 60, and metal shield (external electrode) 70.

The image sensor chip 10 has, on its upper surface (first surface), a pixel region (not shown) and a circuit region including analog circuits and digital circuits. More specifically, for example, the pixel region is arranged at the central portion of the surface of the image sensor chip 10, and the circuit region is arranged around the pixel region. The image sensor chip 10 also has, on its lower surface (second surface parallel to the first surface), a plurality of solder balls 100.

The glass plate 20 is bonded to the upper surface of the image sensor chip 10 by, for example, an adhesive 80 provided in the periphery. The glass plate 20 protects the pixel region of the image sensor chip 10. A region without the adhesive 80 is provided between the glass plate 20 and the image sensor chip 10. This aims at preventing the condensing effect of a microlens (not shown) provided in the pixel region of the image sensor chip 10 from being destroyed because the microlens and the adhesive 80 have almost the same refractive index.

The lens unit 60 is bonded to the glass plate 20 by an adhesive 81. The lens unit 60 includes, for example, an infrared ray (IR) cut filter 30, a plurality of lenses 40, and a lens holder 50 for holding them, and has desired optical characteristics. More specifically, for example, the IR cut filter 30 and the plurality of lenses 40 are provided above the pixel region of the image sensor chip 10, and the lens holder 50 is provided around them.

The metal shield 70 is attached around the image sensor chip 10, glass plate 20, and lens holder 50. The metal shield 70 is bonded to the lens holder 50 by an adhesive 82. This allows the shielding from light that would otherwise strike the side surfaces of the image sensor chip 10. The metal shield 70 is also bonded to the side surfaces of the image sensor chip 10 by a conductive adhesive material 90. The metal shield 70 is thus electrically connected to the image sensor chip 10. The metal shield 70 is, for example, a metal can with an opening portion in the bottom portion. As shown in FIG. 1, when the metal shield 70 is attached to the assembly of the image sensor chip 10, the plurality of solder balls 100 are exposed from the opening portion. The bottom peripheral portion of the metal shield 70 is bonded to the periphery of the lower surface of the image sensor chip 10.

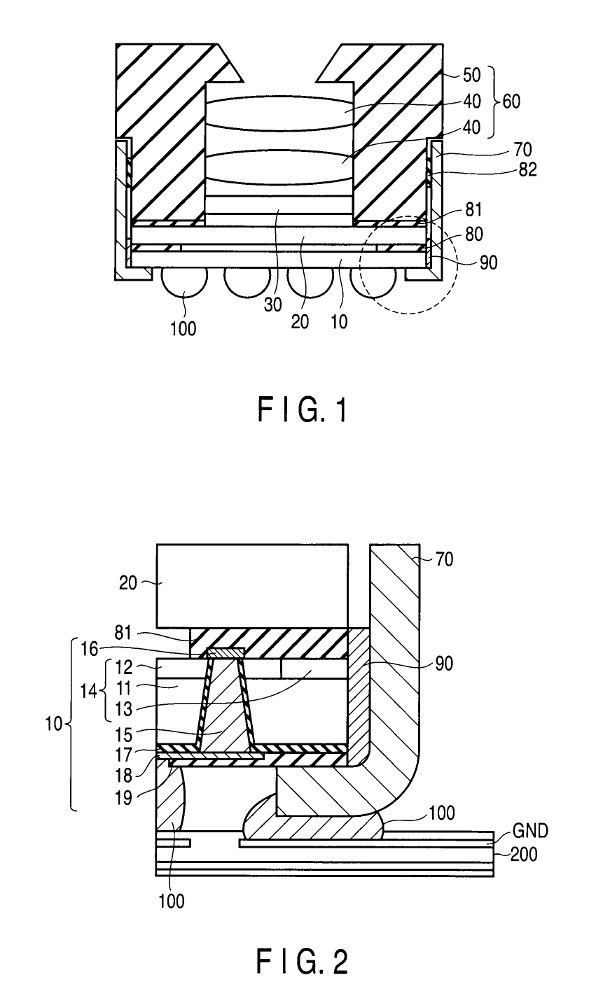

FIG. 2 is an enlarged view of the periphery of the image sensor chip 10 in FIG. 1. Note that FIG. 2 illustrates the camera module mounted on a mount substrate 200.

As shown in FIG. 2, the image sensor chip 10 includes a silicon substrate 14 having a heavily doped p-type substrate 11, n-type epitaxial layer (n-well) 12, and p-well 13, through-via 15, electrode pad 16, insulating film 17, conductive layer (interconnection) 18, and solder resist 19.

In the silicon substrate 14, the n-type epitaxial layer 12 is formed on the upper surface of p-type substrate 11. The n-type epitaxial layer 12 is formed by, for example, VPE or CVD. A p-well (first p-well) (not shown) is formed in the n-type epitaxial layer 12. An n-well with an adjusted impurity concentration is formed in the p-well or n-type epitaxial layer 12, thereby forming a circuit. Especially, the p-well of an analog circuit portion is formed by implanting ions at high energy, and electrically connected to the p-type substrate 11. A p-well is also formed in the pixel region and used as a pixel isolating region. The p-well 13 (second p-well) is formed by implanting ions at high energy into the periphery of the p-type substrate 11 and the n-type epitaxial layer 12 (dicing region). The p-well 13 (second p-well) is independent of the first well.

The electrode pad 16 connected to, for example, the circuit region is formed on the upper surface of the silicon substrate 14. The insulating film 17 is formed on the lower surface of the silicon substrate 14. The interconnection 18 is formed on the insulating film 17. The interconnection 18 and the electrode pad 16 are connected by the through-via 15 formed in the silicon substrate 14. The through-via 15 is insulated from the substrate 11 by the insulating film 17. The solder balls 100 are formed on the interconnection 18. The solder resist 19 is formed on the interconnection 18 and the insulating film 17 except the solder balls 100. The solder balls 100 are connected to interconnections formed on the mount substrate 200.

On the other hand, the bottom portion of the metal shield 70 bonded to the side surfaces of the image sensor chip 10 by the conductive adhesive 90 is electrically connected to the ground interconnection (GND) of the mount substrate 200 via the solder balls 100. That is, the p-well 13 of the image sensor chip 10 is electrically connected to the metal shield 70 by the conductive adhesive 90, and the metal shield 70 is connected to the ground interconnection (GND) via the solder balls 100. This allows enhancement of the grounding of the analog circuit portion.

Note that in the camera module of this embodiment, a conductive material capable electrically connecting the image sensor chip 10 to the metal shield 70 may be used in place of the conductive adhesive 90.

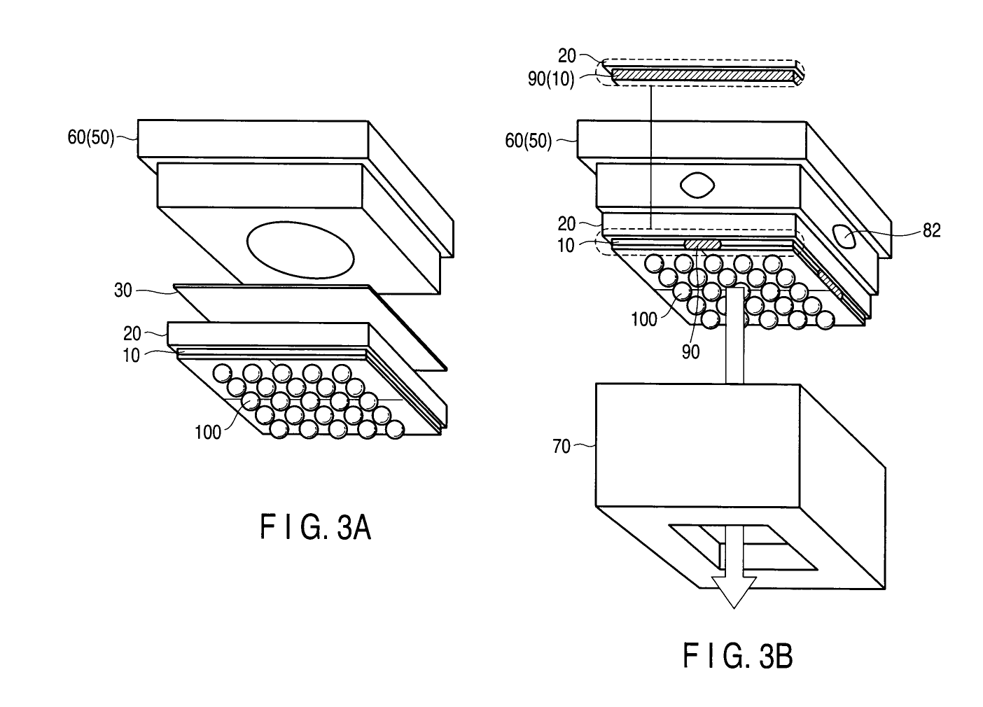

FIGS. 3A and 3B show a method of manufacturing the camera module.

As shown in FIG. 3A, for example, the glass plate 20 is bonded using the adhesive 81 to a wafer substrate with the image sensor formed thereon. After that, a wafer substrate grinding process, through-via formation process, interconnection formation process on the wafer substrate lower surface side, and solder balls formation process are performed. Then, the image sensor chip 10 is singulated. Next, using an adhesive (not shown), the lens unit 60 and the IR cut filter 30 are bonded to the glass plate 20 bonded to the image sensor chip 10.

As shown in FIG. 3B, the image sensor chip 10 and the lens unit 60 are attached and bonded to the metal shield 70. At this time, the adhesive 82 is applied to the side surfaces of the lens holder 50, and the conductive adhesive 90 is applied to the side surfaces of the image sensor chip 10. As indicated by the broken lines in FIG. 3B, the conductive adhesive 90 is preferably applied to the entire side surfaces of the image sensor chip 10. This enables increasing the conductivity from the image sensor chip 10 to the metal shield 70. Note that a conductive material may be used in place of the conductive adhesive 90.

According to the embodiment, the conductive adhesive 90 is applied to the side surfaces of the image sensor chip 10 so that the image sensor chip 10 is bonded to the metal shield 70 by the conductive adhesive 90. The p-well 13 formed at the periphery of the image sensor chip 10 is thus electrically connected to the metal shield 70. When the metal shield 70 is connected to the ground interconnection (GND) of the mount substrate 200, the p-well 13 of the image sensor chip 10 can be grounded from the mount substrate 200 via the metal shield 70. It is therefore possible to suppress the influence of noise and obtain a reliable camera module.

In addition, since the side surfaces of the image sensor chip 10 need only be bonded to the metal shield 70 by the conductive adhesive 90, size reduction of the camera module can be maintained, and assembly is easy.

It should be noted that the camera module explained herein is only exemplary and the embodiment should not be limited to the camera module. The embodiment is also applicable to a semiconductor device comprising: a substrate which includes an analog circuit having a first p-well and has a second p-well at a periphery thereof, the second p-well being independent of the first p-well; and an external electrode which is provided on the substrate and electrically connected to the second p-well of the substrate. This application of the embodiment to the semiconductor allows enhancement of the grounding of the analog circuit portion in the semiconductor device.

Modifications of the camera module according to the embodiment will be described next. In each modification, a description of the same parts as in FIGS. 1 and 2 will not be repeated, and only different parts will be explained.

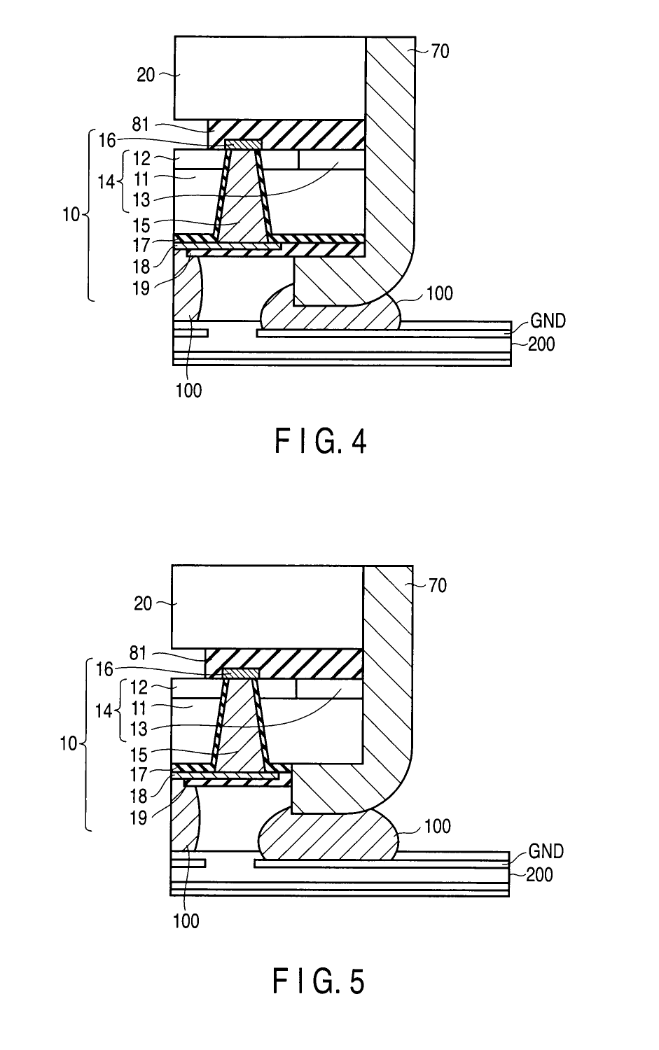

FIG. 4 illustrates the first modification of the camera module according to the embodiment.

As shown in FIG. 4, the first modification is different from FIG. 2 in that the image sensor chip 10 is brought into direct contact with the metal shield 70 without using the conductive adhesive 90. More specifically, the inner diameter of the metal shield 70 matches the outer diameter of the image sensor chip 10. When the metal shield 70 is bonded to the lens unit 60, the metal shield 70 is pressed against the p-well 13 of the image sensor chip 10. They are thus electrically connected.

According to the first modification, the same effects as in the embodiment can be obtained. In addition, according to the first modification, since the conductive adhesive 90 is unnecessary, the manufacturing process can further be facilitated.

FIG. 5 illustrates the second modification of the camera module according to the embodiment.

As shown in FIG. 5, the second modification is different from FIG. 2 in that the insulating film 17 and the solder resist 19 are not formed under the p-well 13. More specifically, the p-well 13 of the image sensor chip 10 is pressed against and thus electrically connected to the metal shield 70 at its side surfaces and lower portion.

According to the second modification as well, the same effects as in the embodiment can be obtained. In addition, according to the second modification, not only the side surfaces but also the lower portion of the p-well 13 is electrically connected to the metal shield 70. This increases the ground area of the p-well 13 so as to ensure grounding of the image sensor chip 10. Note that each of the side surfaces and lower portion of the p-well 13 may be bonded to the metal shield 70 by the conductive adhesive 90.

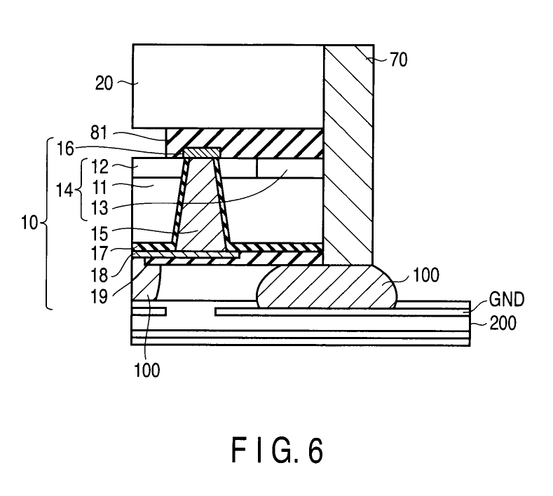

FIG. 6 illustrates the third modification of the camera module according to the embodiment.

As shown in FIG. 6, the third modification is different from FIG. 2 in that the metal shield 70 has no bottom portion so that it is arranged only on the side surfaces of the image sensor chip 10 and pressed against them.

According to the third modification as well, the same effects as in the embodiment can be obtained. In addition, according to the third modification, the metal shield 70 is formed only on the side surfaces of the image sensor chip 10, and has no bottom portion. That is, the metal shield 70 has no angled portions between the side surfaces and the bottom portion. It is difficult to form right-angled portions in the process, resulting in round portions. For this reason, when the metal shield 70 is attached to the lens unit 60, and the angled portions on the lower surface of the image sensor chip 10 abut against the round portions of the metal shield 70, a gap is formed between the metal shield 70 and the side surfaces of the image sensor chip 10. This may make pressing insufficient. In the third modification, however, since no angled portions exist, sufficient pressing can be obtained. Note that the image sensor chip 10 may be bonded to the metal shield 70 by the conductive adhesive 90.

In the embodiment and the first to third modifications, a metal can is used as the metal shield 70. However, the embodiment is not limited to this. Instead of using a metal can, for example, a metal may be deposited on the side surfaces of the image sensor chip 10, and directly connected to the p-well 13.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a substrate which includes a pixel region having a first well and has a second well at a periphery thereof, the second well being independent of the first well;
a lens which is provided above the pixel region in the substrate;
a lens holder which holds the lens; and
a metal shield which is provided on the substrate and the lens holder and electrically connected to the second well of the substrate.

2. The device according to claim 1, wherein the substrate includes a p-type substrate and an n-type epitaxial layer on the upper surface of the p-type substrate, and
the second well is a p-well formed periphery of the n-type epitaxial layer

3. The device according to claim 1, wherein the substrate and the metal shield are connected via a conductive material.

4. The device according to claim 3, wherein the conductive material is applied to entire side surfaces of the substrate.

5. The device according to claim 1, wherein the substrate and the metal shield are connected directly.

6. The device according to claim 1, wherein the metal shield is provided only on side surfaces of the substrate.

7. The device according to claim 1, wherein the metal shield is formed by depositing a metal.

8. The device according to claim 1, wherein the metal shield is provided on side surfaces and a bottom portion of the substrate.

9. The device according to claim 1, wherein the metal shield is connected to a ground interconnection.

10. A semiconductor device comprising:
a substrate which includes an analog circuit having a first well and has a second well at a periphery thereof, the second well being independent of the first well; and
an external electrode which is provided on the substrate and electrically connected to the second well of the substrate.

11. The device according to claim 10, wherein the substrate includes a p-type substrate and an n-type epitaxial layer on the upper surface of the p-type substrate, and
the second well is a p-well formed periphery of the n-type epitaxial layer

12. The device according to claim 10, wherein the substrate and the external electrode are connected via a conductive material.

13. The device according to claim 12, wherein the conductive material is applied to entire side surfaces of the substrate.

14. The device according to claim 10, wherein the substrate and the external electrode are connected directly.

15. The device according to claim 10, wherein the external electrode is provided only on side surfaces of the substrate.

16. The device according to claim 10, wherein the external electrode is a metal shield, and is formed by depositing a metal.

17. The device according to claim 10, wherein the external electrode is provided on side surfaces and a bottom portion of the substrate.

18. The device according to claim 10, wherein the external electrode is connected to a ground interconnection.
